(19) United States
(12) Patent Application Publication
(10) Pub. No.: US 2024/0383781 A1
(43) Pub. Date: Nov. 21, 2024

(54) DISPOSAL OF EFFLUENT WATER FROM AN OFFSHORE OIL AND GAS INSTALLATION

(71) Applicant: CONOCOPHILLIPS COMPANY, Houston, TX (US)

(72) Inventor: Morten Soerli RONAESS, Tananger (NO)

(21) Appl. No.: 18/667,714

(22) Filed: May 17, 2024

Related U.S. Application Data
(60) Provisional application No. 63/503,268, filed on May 19, 2023.

(51) Int. Cl. C02F 1/44; C02F 1/00; C02F 101/10; C02F 101/20; C02F 101/32; C02F 103/10

(52) U.S. Cl. CPC C02F 1/44; C02F 1/004; C02F 2101/101; C02F 2101/105; C02F 2101/203; C02F 2101/32; C02F 2103/10; C02F 2201/001; C02F 2301/08; C02F 2303/16

(57) ABSTRACT

The invention relates to the treatment of wastewater on an offshore hydrocarbon producing rig, where the wastewater is from a variety of sources and has variable content but always includes both oil and particulates. A cross flow membrane filter removes oil whilst dead end type pre-filters are provided to remove particulates which would otherwise quickly erode the membrane filter.

### CROSS-REFERENCE TO RELATED APPLICATIONS

This application is a non-provisional application which claims benefit under 35 USC § 119 (e) to U.S. Provisional Application Ser. No. 63/503,268 filed May 19, 2023 entitled “DISPOSAL OF EFFLUENT WATER FROM AN OFFSHORE OIL AND GAS INSTALLATION,” which is incorporated herein in its entirety.

### FEDERALLY SPONSORED RESEARCH AND DEVELOPMENT

None.

### FIELD OF THE INVENTION

This invention relates to the disposal of effluent water contaminated with oil and particulates, from an offshore oil and gas platform.

### BACKGROUND OF THE INVENTION

Wastewater from processes on an offshore platform and produced water from hydrocarbon wells needs to be disposed of. The water can include for example cutting/waste from drilling operations, jetting process water, drain water and flow back from wells after well stimulation and produced water. The water is normally contaminated with a variety of solid matter and liquid hydrocarbons

Offshore Installations often use CSRI (Cuttings, slurryfication reinjecting) wells to dispose of the liquid waste produced by drilling and operations, as this is the most environmentally friendly and cost-effective alternative. The liquid waste consists of cuttings and waste from drilling operations, jetting water from the process, drain water, flowback fluids and produced water. The wells are critical to be able to dispose of the liquid waste volumes produced. If one of the wells should become unavailable there will be an urgent need to dispose the liquid waste elsewhere. Short-term alternatives would be transport to one of various other CSRI-wells for reinjection or transport (by boat) to an onshore location for disposal. Both these alternative ways of disposal represent an extra cost compared to reinjection in the local CSRI-well. Furthermore, if the liquid waste is not disposed rapidly enough both drilling and production operations will be impaired until a functioning system for handling the waste is in place, causing large losses for the operating company. Should no alternative CSRI-well be available there will be significant extra costs and losses in terms of production and drilling progress unless disposed onshore with significant associated cost.

Therefore, there is a focus to limit the risk of a CSRI-well failure. Each of the CSRI-wells has an estimated volume before the allocated reinjecting domain is “full”, but there is significant uncertainty in these volumes. There is therefore a strong desire for companies to reduce and minimize the reinjected volumes. If the volumes reinjected are reduced, the lifetime of each CSRI-well will be extended. Thus, the costly operation of drilling new wells will either be postponed or canceled. Large cost reductions can be achieved by reducing the CSRI-volumes.

If wastewater is to be disposed of into the sea, it must be processed to remove contaminants. The nature and variety of contaminants in water from a hydrocarbon producing platform, together with the limited available space on an offshore platform, makes this a challenging task.

Previous approaches have involved flotation methods. However, floatation methods struggle to remove particulates. These must be removed and treated to remove any attached oil prior to release to sea.

### BRIEF SUMMARY OF THE DISCLOSURE

The invention more particularly includes a process for disposing of wastewater from an offshore oil and gas platform, wherein the wastewater contains entrained oil droplets and particulate matter, and wherein the process comprises: a) passing the wastewater through two or more pre-filter units to filter out particulates having a dimension greater than 20 micron, the pre-filter unit comprising one or more filter meshes; b) passing the pre-filtered stream through a membrane to remove entrained oil droplets, thereby creating a membrane-filtered stream and an oil rich recirculation stream; c) disposing of the membrane filtered stream by passing it into the sea; and d) disposing of the back wash stream and membrane oil rich reject stream by pumping it into an injection well. Ceramic cross flow membrane filters remove oil in a more efficient process than floatation, and in a process that is continuous. Ceramic filters are also able to remove particulate matter and oil but it has been found that the particulate matter erodes the membrane too quickly. The use of dead end type pre-filters has been found to remove sufficient particulates to allow the ceramic membrane filters to have an acceptable lifespan. However, the dead end type filters can get clogged. The use of an automatic backwash system alleviates this problem.

In step (d) the reject stream may be fed to a holding tank before being pumped into the injection well. Liquid in the holding tank may be further cleaned before being pumped into the injection well.

The membrane may part of a cross flow membrane filter system, which may be a cross flow ceramic filter system.

The membrane system may be made of any suitable material that can withstand the chemistry of the produced water. Example filter media include ceramic, nylon, polypropylene (PP), Polyethersulfone (PES), Polyethersulfone (PES), Polysulfone (PS), and combinations thereof, as well as other commercially available filters. Ceramic filters may include inorganic oxides, alumina, titania, zirconia oxide, silicon carbide, or combinations thereof. Multimedia filters contain multiple layers of filtration media with each layer progressively sized in coarseness and depth. Filters may also come in a variety of pore sizes ranging from ranging from 1 micron to 1,000 micron including 1, 2, 5, 10, 20, 25, 50, 75, 100, 150, 200, 250, 300, 500, 750, 800, 900 and 1,000 micron filters, including all increments in between. Different filters may be used at different times during production dependent upon the well treatment and chemistry of the water produced. For example, one filter type may be used during early production but transition to a second filter type as the well ages. If sulfur concentrations increase a different filter type may be used.

The process may further comprise periodically backwashing the filters. One of the filter units may have a mesh size to filter out particles of 300 micron diameter and above, or depending on the anticipated nature of the particles in the fluid to be treated, 500 micron diameter and above, 800 micron diameter and above or 1,000 micron diameter and above; essentially a range of 300-1000 micron filters, e.g. 500-800 micron filters, such as about an 800 micron filter. The use of a 300 micron filter may depend on the type of reservoir and the use of a 1,000 micron filter may depend on the downstream equipment.

The process may comprise the use of another filter unit that may have a mesh size to filter out particles of 20 micron diameter and above. One or more of the filter units may filter out particles coated with oil or particles with attached oil.

Treatment of wastewater that includes drill cutting fluid and/or jetting fluid and that contains oil and abrasive solids on an offshore rig has technical challenges. The problem is that to dispose of this wastewater in the sea, oil must be removed, and potentially solids as well, but the cross flow membrane filter for oil is eroded quickly by the solids. The solution is to remove solids using one or more back-wash type pre-filters. Back wash filters have not seen any erosion damage, but normal wear and tear and regular backflushing based on Dp is sufficient to remove solids build up.

Examples and various features and advantageous details thereof are explained more fully with reference to the exemplary, and therefore non-limiting, examples illustrated in the accompanying drawings and detailed in the following description. Descriptions of known starting materials and processes can be omitted so as not to unnecessarily obscure the disclosure in detail. It should be understood, however, that the detailed description and the specific examples, while indicating the preferred examples, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term substantially, as used herein, is defined to be essentially conforming to the particular dimension, shape or other word that substantially modifies, such that the component need not be exact. For example, substantially cylindrical means that the object resembles a cylinder, but can have one or more deviations from a true cylinder.

Additionally, any examples or illustrations given herein are not to be regarded in any way as restrictions on, limits to, or express definitions of, any term or terms with which they are utilized. Instead these examples or illustrations are to be regarded as being described with respect to one particular example and as illustrative only. Those of ordinary skill in the art will appreciate that any term or terms with which these examples or illustrations are utilized encompass other examples as well as implementations and adaptations thereof which can or cannot be given therewith or elsewhere in the specification and all such examples are intended to be included within the scope of that term or terms. Language designating such non-limiting examples and illustrations includes, but is not limited to: “for example,” “for instance,” “e.g.,” “In some examples,” and the like.

Although the terms first, second, etc. can be used herein to describe various elements, components, regions, layers and/or sections, these elements, components, regions, layers and/or sections should not be limited by these terms. These terms are only used to distinguish one element, component, region, layer or section from another. Thus, a first element, component, region, layer or section discussed below could be termed a second element, component, region, layer or section without departing from the teachings of the present inventive concept.

While preferred examples of the present inventive concept have been shown and described herein, it will be obvious to those skilled in the art that such examples are provided by way of example only. Numerous variations, changes, and substitutions will now occur to those skilled in the art without departing from the disclosure. It should be understood that various alternatives to the examples of the disclosure described herein can be employed in practicing the disclosure. It is intended that the following claims define the scope of the disclosure and that methods and structures within the scope of these claims and their equivalents be covered thereby.

### BRIEF DESCRIPTION OF THE DRAWINGS

A more complete understanding of the present invention and benefits thereof may be acquired by referring to the follow description taken in conjunction with the accompanying drawings in which:

FIG. 1 is a schematic representation of the filters and membranes;

FIG. 2 is a schematic diagram of the various components of a waste water handling system according to the invention, including tanks, lines, filter, etc.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

Handling process fluids offshore is a difficult task due to the lack of space, the extra cost for transportation to shore or drilling of re-injection wells. The cleaning set-up must be as space-efficient as possible. The inventors recognized the need to pump less fluid into injection wells for disposal and wanted to approach this problem by treating the waste streams from a production to extract relatively pure water suitable for disposal in the sea leaving a residue of smaller volume for injection. This was technically challenging at least because of the variety of and unpredictability of the contents of the waste stream, which was a combination of waste from a number of different sources.

The inventors investigated filtering the waste stream using different combinations of filters/strainers and/or membranes. For example, a test was conducted of a ceramic filter/membrane with an upstream strainer with Pore Size equal 1 mm (1000 μm), located upstream of the feed pump for pump protection. This resulted in the membrane filter quickly becoming clogged.

Another test assembly was made using a number of filters in series: coarse and fine filters prior to treatment in a membrane unit. Due to the large amount of particles back wash filters where chosen. The filters were automatic back-washed on Δp=0.2 bar. The coarse filter has a filter sheet of 800 μm and fine filter of 20 μm filter sheet. A pulsation damper was installed between the fine filter and the membrane to supply liquid to the membranes during backwash of the filters. The membranes were crossflow ceramic membranes. The membrane filter functions as follows: the fluid flows along the inside of a cylindrical membrane tube and permeate (in this case clean water) is pushed through the membrane perpendicular to the flow direction. The retentate is recycled and/or discharged.

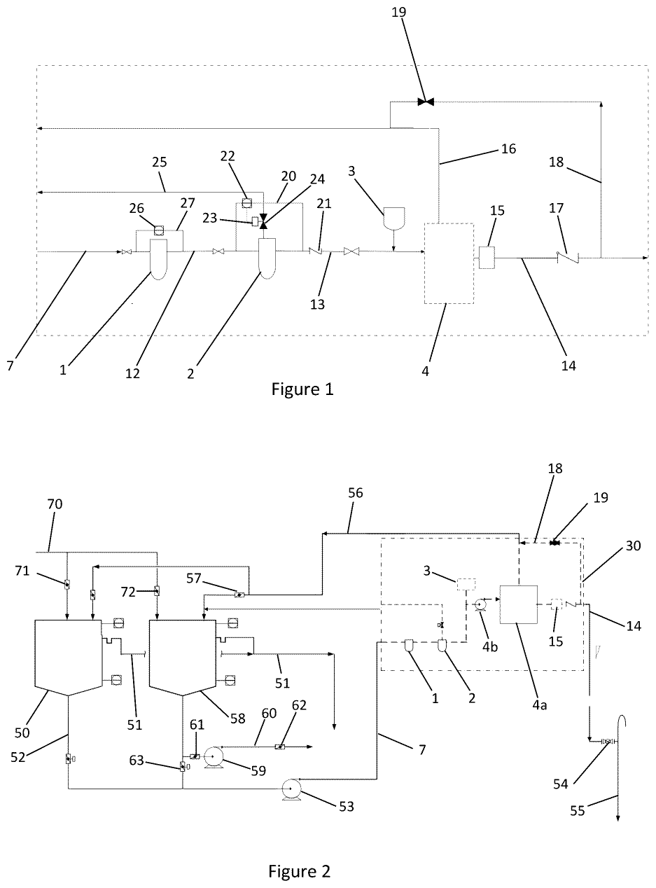

The arrangement of the filtration assembly is shown in FIG. 1. Liquid waste for cleaning enters through line 7 and is fed to a coarse 800 micron filter 1 to filter out large particles, which may damage downstream equipment such as rotating equipment. The filtered liquid is then then fed through line 12 to a 20 micron fine filter 2. The fine filter is intended to remove particles that tend to cause erosion (maximum erosion effect from particles in the 30-50 micron range). The fine filtered liquid then flows through line 13, through one way valve 21, to a membrane and pump unit 4. Feeding into the line 13, upstream of the membrane and pump unit 4, is a pulsation damper 3, whose function is to supply liquid to the membranes during a backwash cycle.

The membranes and pump unit comprises a number of ceramic cross flow membrane filters in a cylindrical arrangement. The fine filtered water from line 13 is fed into the unit and pumped across the front face of the ceramic filter membrane (details not shown in FIG. 1 but are, in themselves, known). The water is pressurized by the pump and a filtrate of very finely filtered water passes under pressure through the ceramic membrane, whilst a residue stream that has not passed through the membrane is fed out of the unit on line 16.

The very finely filtered water emerges from the membrane unit 4 on line 14 and passes through an instrument 15 for measuring the oil content of the filtered water. The line 14 also includes a one way valve 17 for preventing filtered water from re-entering the membrane unit 4. Line 18 branches from line 14 and provides a route for the filtered water to be returned to the system should undue levels of contaminant be found it in, e.g. if the oil content is out of tolerance, as measured by instrument 14. A valve 19 controls whether the return line 18 is open or closed. Line 18 joins the residue/retentate line 16 to be returned to a tank (see FIG. 2) to await being passed through the filter system again.

Returning to the pre-filters, FIG. 1 shows a pressure differential sensor 22 in a line 20 passing around the fine (20 micron) filter 2. Fine filter 2 is a so called dead end type filter and is vulnerable to the building up of filter residue and clogging of the filter. This is detected by the sensing of an increased pressure differential across the filter. A signal from the sensor the causes a valve actuator 23 to open a backwash valve 24 in a backwash line 25 leading from the upstream (dirty) side of the filter, supplied from the clean side of the filter flushing the particles to the re-injection tank. The valve 21 is a one way valve; it will prevent back flow from membrane unit. A small volume of liquid in the filter unit and lines passes backwards through the filter and passes out through the backwash line to a holding tank (see FIG. 2) to be re-filtered at a later time or re-injected to the CSRI.

During a backwash cycle it is important to keep the membrane and pump unit 4 supplied with water at positive pressure. The pulsation damper 3 is provided for this purpose, i.e., to provide a reservoir of water to keep the membrane supplied with water when back wash of filter is ongoing.

The coarse filter 1 is not so susceptible to blockage and has no backwash feature, although the pressure drop across the filter is still measured using a pressure differential sensor 26 in a line 27 passing around the filter 1.

Turning now to FIG. 2, a wastewater handling system is shown schematically. The membrane filter and pre-filter system shown in detail in FIG. 1 and discussed above is shown in dashed line box 30. Some of the components shown in FIG. 1 are also shown inside the dashed line box 30, in which case the same reference numerals are used to designate the same components. An exception is the membrane and pump unit 4 in FIG. 1, which is shown as a separate membrane unit 4a and pump 4b in FIG. 2.

Liquid waste from a mixture of sources is fed from a variety of sources into the system on line 70. Depending on its composition, valves 71 and 72 control whether the waste stream is passed into a first storage tank 50 to be fed to the membrane and filter unit or a second storage tank 58 from which it may be injected into a disposal well. If liquid waste is to be injected into a well for disposal and if it is suitable for having its volume reduced by extraction of water, then it is pumped from the tank 50 though line 52, by means of pump 53, into the membrane and pre-filter system 30.

Line 51 is simply an overflow line to prevent overfilling of the tanks and resulting potential overpressure.

Line 14 emerging from the membrane and pre-filter system 30 carries filtered water suitable for passing into the sea. Valve 54 controls the passing of this stream into conduit 55 terminating in an outlet to the sea.

A filter residue stream, comprising water containing concentrated waste from the membrane and pre-filter system 30, passes along line 56 to a second storage tank 58, via a valve 57. Depending on analysis of the tank contents, it may be pumped from the tank 58 by pump 59 along line 60 into an injection well for disposal. Valve 61, upstream of the pump 59, controls this operation.

If an analysis of the contents if the second tank 57 reveals that further water removal is desirable, the valve 63 may be opened to allow the contents of the second tank 57 to join the flow on line 52 from the first tank being fed into the filter and membrane unit 30. Thus, valve 61 and 63, between them, control routing of the flow. Valve 61 is opened and valve 63 closed for re-injection. Valve 63 is opened and valve 61 closed to direct the stream for processing to remove contaminants.

Valve 62 is an isolation valve for maintenance.

The following examples of certain embodiments of the invention are given. Each example is provided by way of explanation of the invention, one of many embodiments of the invention, and the following examples should not be read to limit, or define, the scope of the invention.

### Example 1

The inventors investigated filtering the waste stream using different combinations of filters/strainers and/or membranes. For example, a test was conducted of a ceramic filter/membrane with an upstream strainer with pore size equal 1 mm (1000 μm), located upstream of the feed pump for pump protection. This resulted in erosion problems in the ceramic membranes, so that they were useless

### Example 2

The applicant tested membrane technology for cleaning slop and other liquid waste from its offshore platforms, including wastewater from drilling operations, jetting water (process water pressurized and jetted into the tank bottom for solid removal), drain water, flow back from well stimulations and produced water (Liquid Waste). Operational problems occurred very fast due to erosion of the membranes. The water is contaminated with large amounts of a variety of solid matters (particles/particulates from reservoir/Organic material/scale etc.) and liquid hydrocarbons. The larger particles (>30 μm) have the weight and the energy to perform erosion of the inner layer of the membranes). The main particles are reservoir debris and scale such as CaSO₄ and BaSO₄, but also Iron (Fe), Magnesium (Mg), Phosphorus (P), Silicon (Si), Strontium (Sr), Zinc (Zn) and Sulfur(S) are present.

A membrane pilot system was field tested on one of the applicant's platforms in the North Sea. The streams were initially filtered by two back wash filters with pore sizes of 800 and 20 μm (1 μm= 1/1000 mm) followed by cross flow ceramic membrane system. In this system, particulates are removed before the wastewater is passed to a membrane for removal of oil and particulates. The filters are installed to prevent the larger particles entering the membranes and causing erosion of the membranes. The trialed fine filter removed 50% of all particles larger than 20 μm. 95% of the particulates larger than 20 μm were between 20 and 30 μm. After a test of 6 months, no measurable erosion of the membrane was detected.

The filters were automatically back washed at Δp=0.2 Bar. The time interval between back washes was varied from zero (continuous back wash) to 45 minutes, depending on the liquid. The cleaning is done in both batches, drain water and jetting of separators and continuous flow, well stimulation flowback.

The pilot unit reduced the reinjection volumes by 22%. the test was designed for maximum 6 m³/h, approx. 25% of full flow during flowback (continuous flow). The main task for the test was to verify the membranes sustainability when particle removal was incorporated in the set-up for the membrane skid.

In closing, it should be noted that the discussion of any reference is not an admission that it is prior art to the present invention, especially any reference that may have a publication date after the priority date of this application. At the same time, each and every claim below is hereby incorporated into this detailed description or specification as a additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
1. U.S. Pat. No. 8,409,442, US2013193072, Water Separation Method and Apparatus (2013)
2. U.S. Pat. No. 10,723,643, Method of Recovering Oil or Gas and Treating the Resulting Produced Water (2020)

1. A process for disposing of wastewater from an offshore oil and gas platform, wherein the wastewater contains entrained oil droplets and particulate matter, and wherein the process comprises:
a) passing the wastewater through two or more pre-filter units to filter out particulates having a dimension greater than 20 micron, the pre-filter unit comprising one or more filter meshes;
b) passing the pre-filtered stream through a membrane to remove entrained oil droplets, thereby creating a membrane-filtered stream and an oil rich recirculation stream;
c) disposing of the membrane filtered stream by passing it into the sea; and
d) disposing of the oil rich recirculation stream by pumping it into an injection well.

2. The process according to claim 1, wherein in step (d) the reject stream is fed to a holding tank before being pumped into the injection well.

3. The process according to claim 3, wherein liquid in the holding tank is further cleaned before being pumped into the injection well.

4. The process according to claim 1, wherein the membrane is part of a cross flow membrane filter system.

5. The process according to claim 4, wherein the membrane is part of a cross flow ceramic filter system.

6. The process according to claim 1, further comprising periodically backwashing the filters, wherein backwash is disposed of with the oil rich recirculation stream.

7. The process according to claim 1, wherein a first filter unit has a mesh size to filter out particles of 300-1000 micron diameter and above.

8. The process according to claim 7, wherein the first filter unit has a mesh size from 500 micron to 800 micron.

9. The process according to claim 8, wherein the first filter unit has a mesh size of about 800 micron.

10. The process according to claim 7, wherein a second filter unit has a mesh size to filter out particles of 20 micron diameter and above.

11. The process according to claim 1, wherein the first and/or second filter units filter out particles coated with oil or particles with attached oil.
